(19) United States
(12) Patent Application Publication
(10) Pub. No.: US 2002/0084782 A1
(43) Pub. Date: Jul. 4, 2002

(54) Noise detector and suppressor for magnetic resonance imaging equipment

(76) Inventor: Warren Guthrie, West Olive, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 09/754,495

(22) Filed: Jan. 4, 2001

(51) Int. Cl. G01V 3/00

(52) U.S. Cl. 324/307

(57) ABSTRACT

An improved transient interference detector and suppressor for an MRI system infers the presence of transient interference in a desired frequency range (in-band signals) by comparing the amplitude of near-band signals to an expected noise reference level. If the near-band signals exceed the expected noise reference level, the presence of transient interference in the in-band signals is concluded. The detector and suppressor may include an automatic adjustment circuit for automatically adjusting the expected noise reference level based on measured statistical information. The detector and suppressor may also require the near-band signals to exceed the expected noise reference level at least twice in a predetermined period before the presence of interference is inferred. A voltage limiter may also be applied to the near-band signals prior to comparison with the expected noise reference level.

### BACKGROUND OF THE INVENTION

This invention relates generally to magnetic resonance imaging equipment, and more particularly to a method for reducing transient noise that interferes with the desired signal and may decrease the quality of the image that is produced.

Magnetic resonance imaging, or “MRI,” is an excellent medical diagnostic tool that has been around for several decades. The details of MRI are well-known and need not be repeated herein. In general, MRI involves placing a subject, such as a person, in a magnetic field of known strength. The hydrogen atoms in the subject, which are typically the atoms that are used for imaging in current MRI machines, will have a resonant frequency that is directly proportional to the applied magnetic field. By “shaping” the static magnetic field through the use of gradient coils, it is possible to produce a static magnetic field of known quantity at a single isolated region within the subject. This region is generally referred to as a voxel, and may be on the order of one cubic millimeter. By imaging thousands of these individual voxels, an overall image of the subject can be recreated.

The imaging of an individual voxel involves applying a radio frequency to the subject that corresponds to the resonant frequency of the voxel undergoing imaging. This resonant frequency is also known as the Larmor frequency. A certain number of hydrogen atoms in the voxel being imaged will absorb energy from the radio signal, which will cause them to switch spin states from a low energy state to a high energy state. After the radio signal is terminated, a certain number of hydrogen atoms in the high energy state will relax back to the low energy state, giving off a signal of known frequency during this relaxation process. By detecting this emitted signal, it is possible to determine the relative hydrogen content of the voxel being imaged. If the subject being imaged is a human, the different concentrations of hydrogen in the different human tissues will produce different signals for the voxels of different tissues. The different signals allow an image to be reconstructed such that it corresponds to the different tissues in the human body.

The signal emitted by the hydrogen atoms when relaxing from a high energy state to a low energy state is detected by a receiving antenna or coil that is positioned around-the subject being imaged. In the case of MRI's designed for imaging humans, the receiving antenna or coil is generally cylindrically shaped with the person positioned in the center of the cylinder. The MRI machine may contain a number of different coils of different size, location, and configuration in order to image different parts of the human body. In addition to the signals emitted by the relaxing hydrogen atoms, the detector coils or antennas will sense additional noise or interference signals. These noise or interference signals are desirably removed from the detected signal in order to produce a better image.

One prior art method for reducing the noise or interference in the receiving antennas is disclosed in U.S. Pat. No. 5,525,906 issued to Crawford et al., the disclosure of which is hereby incorporated herein by reference. In this method, which is depicted in block diagram in FIG. 7 herein, the signal from the receiving antenna is split into a detect path signal 1020 and a receive path signal 1022. The detect path 1020 passes through a band pass filter 1024 which removes broad band thermal noise from the detect path signal 1020. The detect path signal 1020 then passes through an amplifier 1026 before being input into a notch or band reject filter 1028. Notch filter 1028 is designed to reject all frequencies that occur within the desired signal frequency range, which has a known bandwidth. The output 1030 of filter 1028 will thus consist of unfiltered noise. The unfiltered noise 1030 is input into a comparator 1032 which compares this signal to a voltage threshold 1034. If the unfiltered noise signal 1030 exceeds the voltage threshold 1034, comparator 1032 outputs a signal at 1036 that causes switch SW1 to open, thereby blanking the output 1038. If the unfiltered noise signal 1030 does not exceed the voltage threshold 1034, the comparator outputs signal 1036, which leaves switch SW1 closed such that the receive signal 1022 is passed through to output 1038, after passing through delay filter 1040. The purpose of delay filter 1040 is to delay the signal on the receive path 1022 from reaching switch SW1 prior to comparator output signal 1036 reaching switch SW1. Such a system is described in more detail in the U.S. Pat. No. 5,525,906 patent, particularly in reference to FIGS. 3 and 4 in the corresponding disclosure therein. While this prior art method has been successful in producing images of higher clarity, the need still exists for improved imaging techniques.

### SUMMARY OF THE INVENTION

Accordingly, the present invention provides an improved method and apparatus for increasing the quality of MRI images. The present invention achieves this improved quality by providing an improved method for detecting transient noise that is generated in the MRI system.

According to one embodiment of the present invention, a method is provided for detecting interference in a signal received from an MRI receiving antenna. The method comprises the steps of passing the signal through a voltage limiter to produce a limited signal. The limited signal is then passed through a filter designed to remove frequencies within the signal that are within a desired frequency bandwidth to produce a limited, filtered signal. The limited, filtered signal is then compared to a noise reference level. If the limited, filtered signal exceeds the noise reference level, it is determined that the MRI signal likely includes transient interference.

According to another aspect of the present invention, a method is provided for detecting interference in the signal received from an MRI receiving antenna. The method includes passing the signal through a filter designed to remove frequencies within the signal that are within a desired frequency band in order to produce a filtered signal. The filtered signal is then compared to a noise reference level. The signal is determined to likely contain transient interference if the filtered signal exceeds the noise reference level at least twice within a predetermined time period.

According to still another aspect of the present invention, a method is provided for detecting transient interference in a signal received from an MRI receiving antenna. The method includes filtering out from the MRI signal those frequencies that are within a desired signal bandwidth to produce a filtered signal. A reference noise signal is generated that has a voltage that is a desired number of standard deviations away from a mean value of the filtered signal. The filtered signal is then compared to the reference noise signal and it is determined that the filtered signal likely includes transient interference if the filtered signal exceeds the reference noise signal at least once.

In other aspects of the invention, interference detection and/or suppression systems are provided for implementing the foregoing methods. The detection methods and apparatuses may include any combination or permutation of the following three elements: a voltage limiter, an automatic threshold adjustment circuit, and a double voltage-crossing detector. In still other aspects of the invention, the noise reference level may be automatically adjusted based on a variety of factors, such as the statistical characteristics of the incoming noise.

The methods and apparatuses of the present invention provide improved clarity in MRI images by more accurately discerning whether or not the signal in an MRI receiving coil is corrupted by transient noise that exceeds an acceptable level. By more accurately determining whether transient interference is present, appropriate steps can be taken from preventing these transient interference signals from being used to produce image data. These and other advantages of the present invention will be apparent to one skilled in the art in light of the following specification when read in conjunction with the accompanying drawings.

### BRIEF DESCRIPTION OF THE DRAWINGS

FIG. 1 is a block diagram of an MRI system according to one aspect of the invention;

FIG. 2 is block diagram of a first embodiment of an interference detector and suppressor according to the present invention;

FIG. 3 is a block diagram of an automatic threshold adjustment circuit used in conjunction with the interference detector and suppressor of FIG. 2;

FIG. 4A is a partial, detailed schematic of a second embodiment of an interference detector and suppressor according to the present invention;

FIG. 4B is a partial, detailed schematic of the second portion of the circuit depicted in FIG. 4A;

FIG. 5 is a block diagram of a digital implementation of an interference detector and suppressor of the present invention;

FIG. 6 is a detailed, block diagram of the digital signal processor of FIG. 5; and

FIG. 7 is a block diagram of a prior art interference detector and suppressor system.

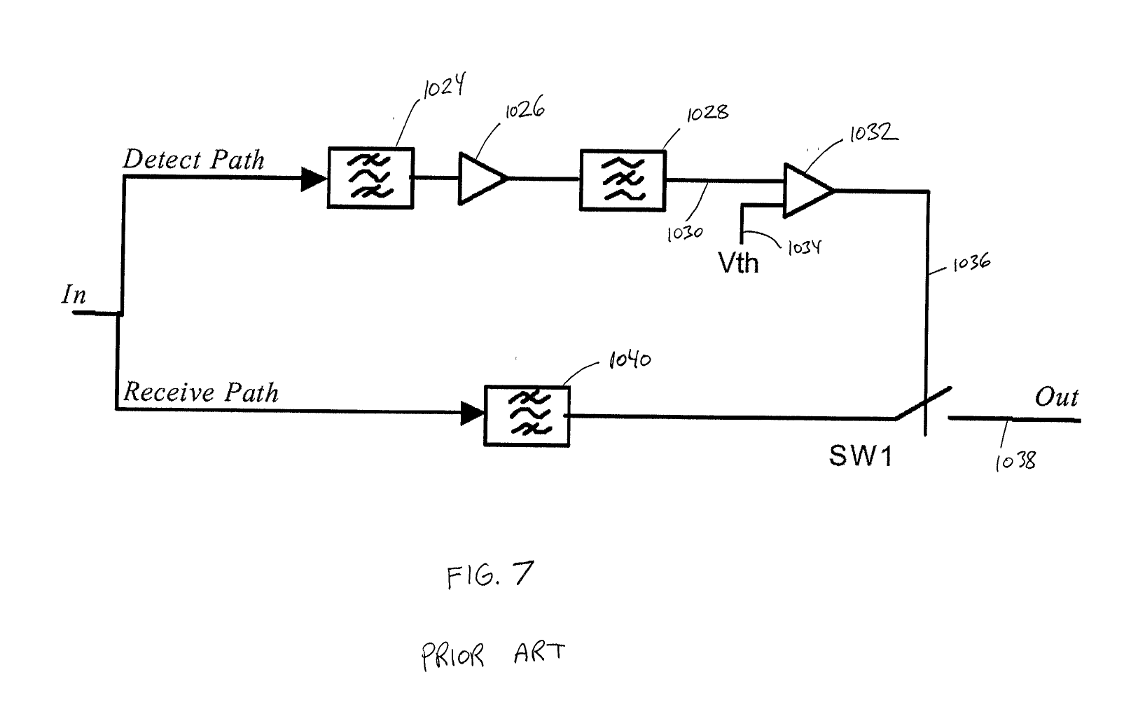

### DETAILED DESCRIPTION OF THE PREFERRED EMBODIMENTS

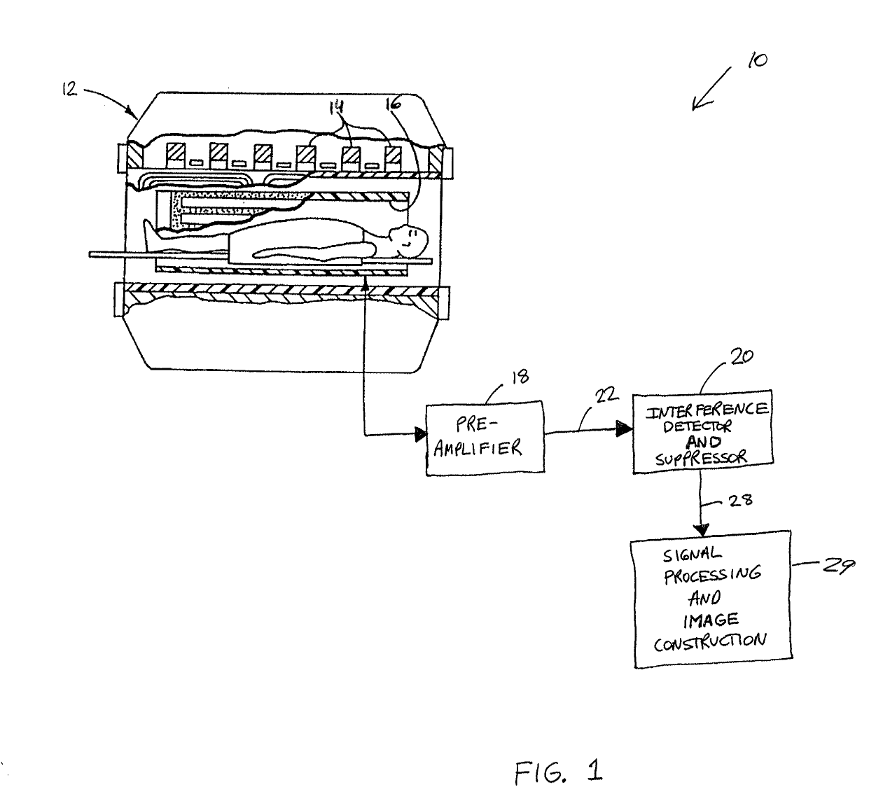

The present invention will now be described with reference to the accompanying drawings wherein like reference numerals correspond to like elements in the several drawings. A block diagram of an MRI system 10 is depicted in FIG. 1. MRI system 10 includes a magnet assembly 12, the details of which are not part of the present invention. As an illustrative example, magnet assembly 12 may include a polarizing magnet 14 and a radio frequency (RF) coil 16, both of which generally surround a patient being imaged. RF coil 16 may be used to both transmit RF signals and detect the MRI image signals, or separate coils may be used for transmission and detection. The MRI image signals that are detected by RF coil 16 are first typically passed to a pre-amplifier, such as pre-amplifier 18 in FIG. 1. From pre-amplifier 16, the signals are passed along line 22 to interference detector and suppressor 20, which is part of the present invention. After passing through interference detector 20, the signals are sent along line 28 to a signal processing and image construction module 29, which may comprise a number of different components such as computers, computer terminals, monitors, and memory devices. Signal processing and image construction module 29 forms no part of the present invention, and the details of one example of such a module can be found in U.S. Pat. No. 5,525,906, the disclosure of which is incorporated herein by reference.

Interference detector and suppressor 20 determines whether the MRI signals on line 22 likely contain transient interference that would improperly be interpreted as image, or desired, signals. Interference detector and suppressor 20 relies on the fact that the incoming signals contain three different types of signals: (1) the desired signals, which are used to generate images, (2) thermal noise, which is always present and has a normal, Gaussian distribution, and (3) transient interference, which occurs sporadically and usually is the result of sparks, or other temporary interference events. The desired signals have a known frequency range. For example, if a one Tesla magnetic field is applied, the resonant frequency of the hydrogen atoms will be approximately 42.57 MHz, and the desired signal will be confined to approximately 400 kHz above and below this frequency. Different magnetic field strengths, and different atoms used for imaging, will produce different frequency ranges for the known signals, as would be known by one skilled in the art. The thermal noise is present at all frequency levels and is treated by interference detector and suppressor 20 like a random variable having a normal distribution. The transient interference can occur at any frequency, but only those interference events that produce frequency components within the desired frequency range are of interest, as those outside this range are filtered out.

In general overview, interference detector and suppressor 20 operates by inferring the presence or absence of transient interference within the desired frequency range by looking at the amplitude of the frequencies just outside the desired frequency range. The frequencies just outside the range of the desired frequencies are referred to as near-band frequencies. The amplitude of the near-band signals is compared to a noise reference signal, which is set at a level that will almost always exceed the thermal noise (due to the randomness of the thermal noise, it is not possible to guarantee that any given signal, other than an infinite signal, will always exceed the thermal noise). If the near-band frequencies contain signals that exceed the noise reference signal, then it is concluded that this excess is due to a transient interference event. Furthermore, it is assumed that the presence of transient interference in the near-band signals indicates that the transient interference also contains interference signals in the desired frequency range. Appropriate corrections are then taken, such as blanking the detected signal such that it is not used for imaging.

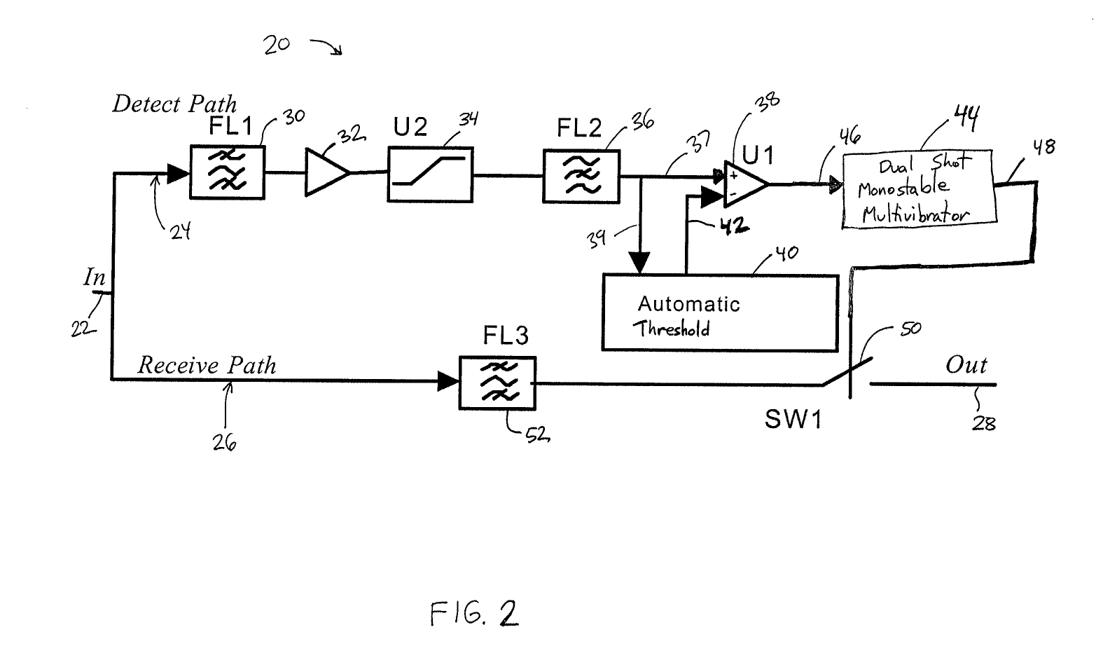

A block diagram of an interference detector and suppressor 20 according to the present invention is depicted in block diagram in FIG. 2. The input 22 into interference suppressor 20 consists of the signals received from the detector coils or antennas that are positioned around the subject being imaged. Interference suppressor 20 splits the signals into two paths. These two paths are labeled detect path 24 and receive path 26. Detect path 24 generally operates to determine if the input signals include transient interference. If there is excessive transient interference, switch SWI is opened to thereby prevent the signal on receive path 26 from reaching the output 28. This process of opening switch SWI to prevent the signal on receipt path 26 from reaching output 28 is generally known as “blanking.” When the signal on receipt path 26 is blanked, no image information is generated for the particular voxel which was blanked. Excessive blanking, therefore, destroys the quality of the image that is generated, and leads to imaging artifacts that are sometimes referred to as corduroy or zebra artifacts. Thus, it is desirable to ensure that blanking only occurs when the transient interference is present, and not falsely blank due to minor variations in the thermal noise level that are inherent in the random nature of the thermal noise.

The first component in detect path 24 is a band pass filter 30 designed to filter out broad band noise. Band pass filter 30 generally filters out those frequencies which are widely outside of the imaging frequencies, thus leaving the imaging frequencies and the near-band frequencies. While it is possible to omit band pass filter 30 and thus define the near-band frequencies as all incoming frequencies outside the desired frequency range, it is preferable to use broad band filter 30 to filter out those filters that are far-removed from the desired frequency range. The precise bandwidth of the frequencies that are passed by broad band filter 30 generally is a function of the detector coils that are present in the MRI system. For example, with body coils, which generally have a lower Q than other imaging coils, it may be desirable to have broad band filter 30 pass an approximately 20 MHz range of frequencies centered around the Larmor frequency. With other types of coils, it may be desirable to have broad band filter 30 pass a narrower range of frequencies, such as, but not limited to, several megahertz. In general, where there are more than one type of imaging coils in the MRI machine, broad band filter 30 is preferably set to accommodate the imaging coil having the lowest Q rating, where Q is the center frequency divided by the 3 db frequency. While broad band filter 30 preferably is centered around the Larmor frequency, it would also be possible to displace the center of the pass band of broad band filter 30 from the Larmor frequency such that the near-band frequencies are not equally divided above and below the imaging frequencies.

After the signal on detect path 24 passes through band pass filter 30, it is amplified by a low noise amplifier 32. After passing through amplifier 32, the signal is input into a voltage limiter 34. Voltage limiter 34 limits both positive and negative voltages that exceed a predetermined amount. After passing through voltage limiter 34, the signal is applied to a notch filter 36. Notch filter 36 is designed to filter out the frequencies in which the desired signals are found. For example, in a one-Tesla system, the desired signals are generally confined to a 400 kHz band centered at 42.57 MHz. In such a system, notch filter 36 would filter out the frequencies from 42.17 MHz to 42.97 MHz, leaving only the signals confined to the near-band frequencies. The effective “sharpness” of the notch in notch filter 36 is increased by the presence of limiter 34 in front of it.

After passing through notch filter 36, the signal is split and is sent to a comparator 38 and an automatic threshold adjustment circuit 40. Comparator 38 compares the output of notch filter 36 (on line 37) to a voltage threshold level on comparator input 42. The voltage threshold at comparator input 42 is generated by automatic threshold adjustment circuit 40, and is designed to be at a level that is above the thermal noise in the system the majority of the time, such as, for example, 99.999%. Thus, if the output of notch filter 36 exceeds the voltage threshold at 42, it is assumed that this excessive signal is due to an interference event. In such a case, comparator 38 outputs a signal to a dual-shot monostable multivibrator 44. Multivibrator 44 has an input 46 and output 48. Multivibrator 46 generates a high signal at its output 48 only if input signal 46 exceeds a predetermined level two or more times in a predetermined time period. In the current embodiment, the input 46 to multivibrator 44 has to go high at least twice within a 100 nanosecond period before the output 48 will have a high signal. If the output 48 of multivibrator 44 is high, switch 50 will be opened to thereby interrupt the electrical connection between receive path 26 and output 28. The opening of switch 50 blanks the measured signal and prevents it from being used in constructing an image for as long as the signal is blanked.

The requirement of having a double voltage crossover, i.e. two comparator outputs 46 that are high within a predetermined time period, before blanking the signal on receive path 26 adds further sensitivity for distinguishing between thermal noise and transient interference. It has been found empirically that transient interference due to sparking has a strong AC component with a period near the Larmor frequency of the atom used for imaging. Thus, in the case of a 0.7 Tesla system used to image hydrogen, if line 37 exceeds voltage threshold signal 42 once due to transient interference, it will likely also exceed voltage threshold 42 another time approximately within the next 30 nanoseconds or so. Dual-shot multivibrator 44 will then be activated causing switch 50 to blank the receive path 26 signal. Because the transient interference has this strong periodic component, it is very unlikely that the transient interference will cause comparator output 46 to go high only once within a 100 nanosecond period. If, on the other hand, comparator output 46 goes high because the thermal noise undergoes a random, temporary fluctuation that exceeds the noise threshold level on line 42, it is very unlikely that this thermal noise fluctuation will repeat itself within a given time period. Thus, dual-shot multivibrator 44 helps distinguish true transient interference from wide, transient variations in the thermal noise which are generally non-periodic. It will, of course, be understood by those skilled in the art that the invention is not limited to a timewindow for multivibrator 44 of 100 nanoseconds. This time window could be set at any length that is 2 periods or longer than any strong periodic components of the transient interference.

Receive path 26 includes a band pass filter 52 whose primary purpose is to delay the signal on receive path 26 by an amount generally equal to the delay in detect path 24. Thus, if the input signal 22 detects interference, the delay of filter 52 will prevent this signal from being transmitted through switch 50 prior to the detection of the interference and consequent opening of switch 50. Band pass filter 52 also filters out frequencies that are outside of the desired frequency range.

Automatic threshold adjustment circuit 40 automatically sets a voltage threshold at a desired level above the mean value of the thermal noise coming in on input 39. More precisely, automatic threshold adjustment circuit 40 produces a voltage at output 42 that is a predetermined number of standard deviations above the mean value of the thermal noise at input 39. The thermal noise entering circuit 40 at input 39 generally has a normal, Gaussian distribution with a mean value of zero volts. (The zero volt mean value is obtained by including a blocking capacitor at an appropriate location in interference detector and suppressor 20 to strip off any DC component of the thermal noise.) For example, automatic threshold circuit 40 could be set to produce an output voltage 42 that is at the 3 sigma level above the mean value of the input thermal noise at 39. If automatic threshold adjustment circuit 40 is so designed, comparator 38 will be comparing the instantaneous value of the noise coming through notch filter 36 with a voltage that is set at 3 sigmas above the mean value of the past noise that has come through notch filter 36. Therefore, the normally distributed thermal noise coming from the output of notch filter 36 will only exceed the threshold voltage on line 42 about one percent of the time. In this example, the system would blank approximately 1 percent of the time. Stated alternatively, interference detector and suppressor 20 would interpret any voltage that exceeds threshold voltage 42 to be transient noise that must be blanked. Therefore, the voltage at input 42 into comparator 38 should be set high enough such that the probability of blanking due to thermal noise, rather than transient interference, is acceptably low. In practice, the voltage at 42 is set to be such that the likelihood of the thermal noise on line 37 exceeding it is on the order of 0.001%.

Automatic threshold adjustment circuit 40 has the advantage that it automatically adjusts the voltage at output 42 according to the statistical characteristics of the input noise at 39. Thus, if circuit 40 is set to produce an output voltage at 42 that is 3 sigmas above the mean value of the input noise at 39, circuit 40 will automatically adjust the voltage level at 42 as the variance of the input noise 39 changes. For example, there may be several different receiving antennas in the particular MRI machine being used in conjunction with noise suppressor 20. One receiving antenna may tend to experience thermal noise that has a larger variance than another receiving antenna. When personnel switch using one antenna and begin using the other, automatic threshold adjustment circuit 40 will automatically adjust output 42 to remain at the 3 sigma level above the mean value of the thermal noise of that particular receiving antenna. Circuit 40 will also automatically adjust for temperature variations that change the statistical characteristics of the thermal noise.

Automatic threshold adjustment circuit 40 operates generally as follows. The input 39 is coupled to the positive input terminal 54 of a comparator 56. Comparator 56 includes a negative input terminal 58 which is coupled to a feedback path 60 as will be discussed more herein. Comparator 56 produces either a positive or negative voltage depending upon the relative voltages of the inputs 54 and 58. If the voltage at input 54 exceeds the voltage at input 58, comparator 56 will output a positive voltage. If, on the other hand, the voltage at input 58 exceeds the voltage at input 54, comparator 56 will output a negative voltage. Comparator 56 will therefore always output either a positive or negative voltage, both of which preferably will have the same absolute value. For purposes of discussion, it will be assumed that the output of comparator 56 is either plus or minus 10 volts, although it will be understood by one skilled in the art that other voltage levels could be selected. The output of comparator 56 is connected on line 62 to a summer 64 which also receives a statistical offset input 66. Summer 64 sums the voltages received from line 62 and the statistical offset voltage 66 and delivers this sum to a switch 68. Switch is open at all times when the MRI machine is not gathering image data and is closed at all times while it is gathering image data. More precisely switch 68 is only closed during the time window after which the MRI machine has generated the RF signals that are used to excite the hydrogen atoms in the subject being imaged. When switch 68 is closed, the output of summer 64 has a direct connection along line 70 to an integrator 72. Integrator 72 integrates the voltages on line 70 and outputs the integrated voltage at 74. The integrated voltage 74 is then split among two branches. One branch is the feedback path 60 which is fed into negative terminal 58 of comparator 56. The other branch 76 is fed into a multiplier 78. Multiplier 78 multiplies the voltage on branch 68 by a threshold offset voltage 80. The output of multiplier 78 is fed on line 42 into the negative input terminal of comparator 38.

Statistical offset voltage 66 and threshold offset voltage 80 are used in combination to determine how high above the mean of the voltage on line 39 the voltage on line 42 should be set. For example, suppose it was desired to set the voltage on line 42 to be at a level corresponding to 9 sigmas above the mean value of the voltage on line 39. One way of implementing this would be to set statistical offset voltage 66 at a level such that a 1 sigma voltage is produced by the output of integrator 72. Threshold offset 80 would then be set at a value of nine and the output 74 of integrator 72 would be multiplied by multiplier 78 by the value 9, yielding a 9 sigma voltage at output 42. Alternatively, statistical offset 66 could be set at a level to produce a 2 sigma voltage on line 74. Threshold offset 80 would then be set at a value of 4.5, causing the output of multiplier 78 to again be set to a 9 sigma voltage level. Infinite variations are, of course, possible. In short, threshold offset 80 multiplies the desired deviation that is set by statistical offset 66 by any desired multiplier.

The desired deviation set by statistical offset voltage 66 is determined with reference to the output of comparator 56. For example, assume that comparator 56 produces either a positive 10-volt output or a negative 10-volt output on line 62. If it were desired to have a 1 sigma voltage on line 74, i.e., the approximately 68% level, statistical offset 66 should be set to −3.6 volts. −3.6 volts is arrived at by multiplying the positive 10 volt output of comparator 56 by 0.32 and summing that product with −10 volts multiplied by 0.68. The 10 volts are multiplied by 0.32 because comparator 56 will desirably have a positive 10 volt output approximately 32% of the time, in order to create a 1 sigma voltage at 74. Likewise, comparator 56 will have an output of −10 volts approximately 68% of the time in order to create a 1 sigma voltage at line 74. Thus, if comparator 56 has a plus or minus 10 volt output, statistical offset 66 has a voltage of negative 3.6, and threshold offset 80 has a voltage of 9, the output voltage 42 will be at a level that is 9 sigmas above the mean input voltage 39. Automatic threshold adjustment circuit 40 can be implemented either in digital or analog form.

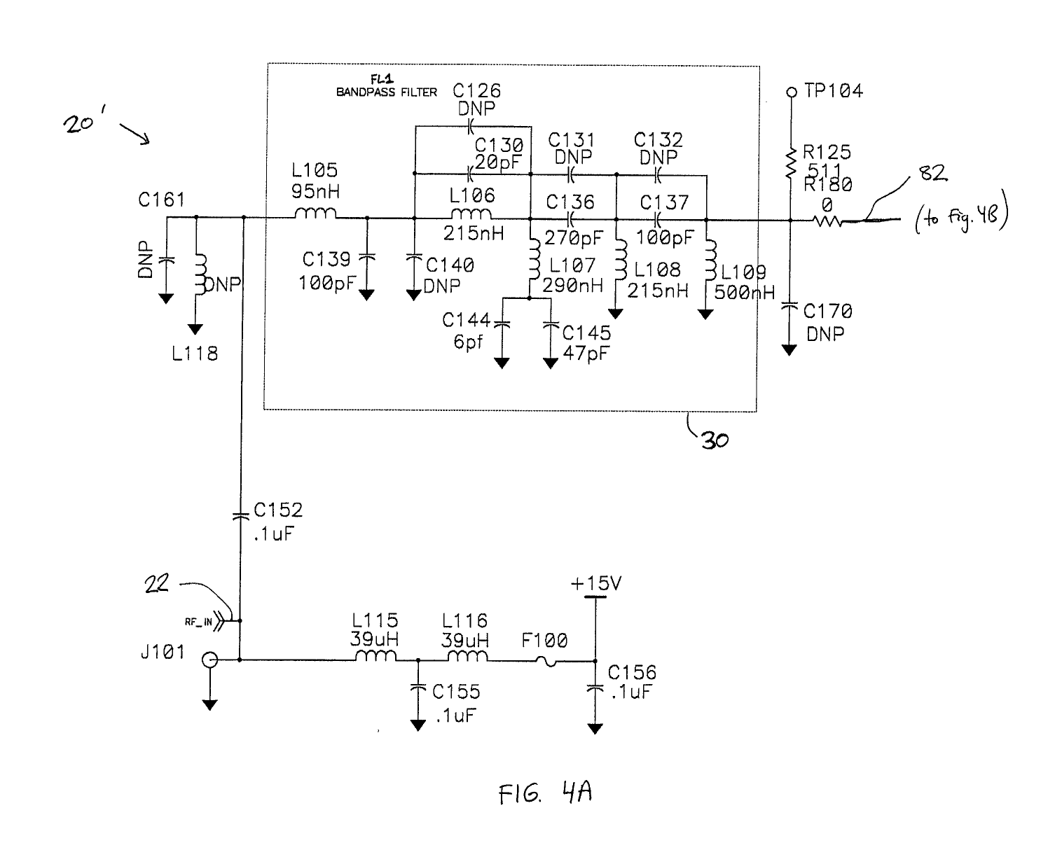

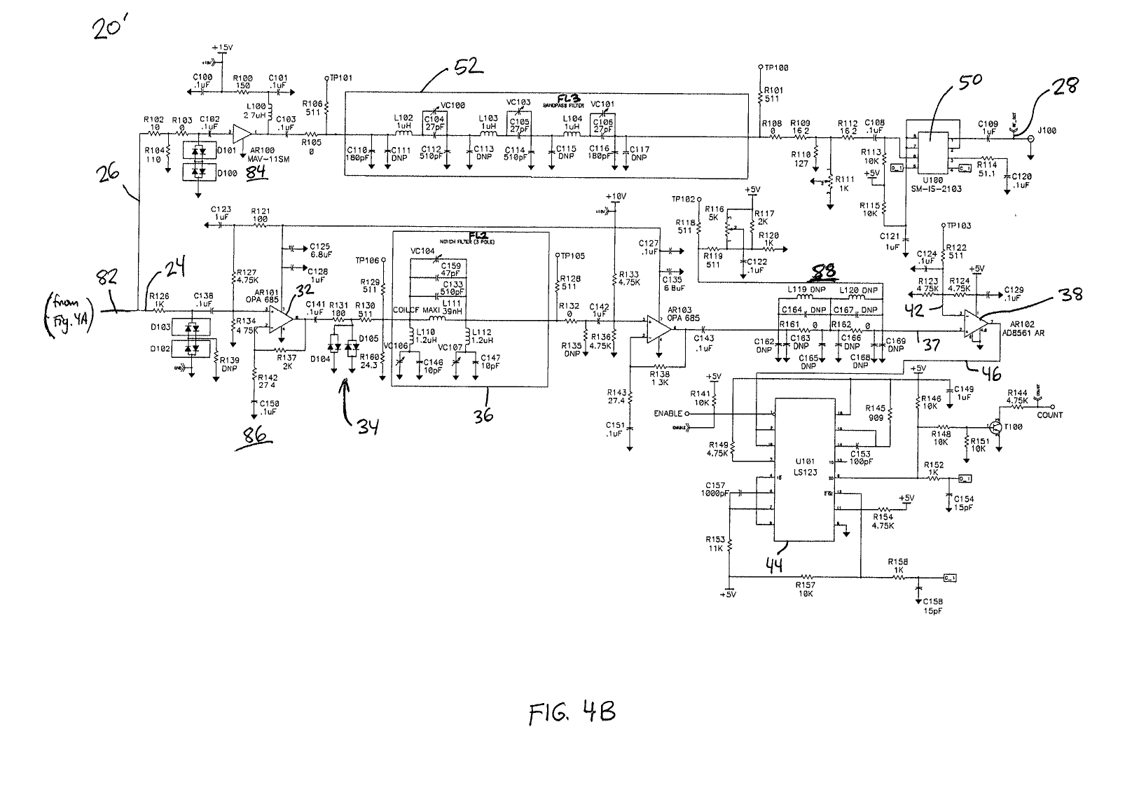

A second embodiment of interference detector and suppressor 20′ is depicted in detailed schematic form in FIGS. 4a and 4b. Interference suppressor and detector 20′ implements all of the features of interference detector and suppressor 20 with the exception of automatic threshold adjustment circuit 40. The threshold voltage in interference suppressor and detector 20′ does not automatically adjust itself, but rather is manually adjustable. The input signal 22 enters circuit 20′ via a coaxial cable which has one of its terminals connected to ground, as indicated by the J101 symbol. The input signal 22 then passes through a blocking capacitor C 152, which strips off any DC component of the input signal, prior to being input into bandpass filter 30. Bandpass filter 30 is the same as bandpass filter 30 in interference detector and suppressor 20, with the exception that it has a different location in interference detector and suppressor 20′ . Specifically, bandpass filter 30 in interference detector and suppressor 20′ is located prior to the split between detect path 24 and receive path 26. Bandpass filter 30 can be placed in either position in accordance with the present invention. After passing through bandpass filter 30, the input signal is split between detect path 24 and receive path 26. Receive path 26 first passes through an amplifier circuit 84 prior to being input into bandpass filter 52. Amplifier circuit 84 provides isolation between detect path 24 and receive path 26, along with providing sufficient gain via amplifier ARlO0 to compensate for the losses in bandpass filter 52. The two sets of diodes D10 and D100 in circuit 84 protect the amplifier AR100 from potentially large signals that might damage the amplifier. The output of bandpass filter 52 is sent to switch 50 which, in this embodiment, is a radio frequency switch manufactured by the Olektron Corporation of Beverly, Mass. under part number SM-IS-2103. When switch 50 is closed, the output of filter 52 passes through switch 50 and out to output 28. When switch 50 is open, the signal from bandpass filter 52 is blanked and there is no output at 28. Switch 50 is controlled by the inputs to pins 4 and 5, which are coupled at C_1 and D_1 to detect path 24, as discussed below.

Signals on detect path 24 first pass through an amplifier circuit 86 before being input into limiter 34. Amplifier circuit 86 generally amplifies the signal on line 24 to a voltage high enough to allow limiter 34 to be constructed out of diodes. The diode sets D102 and D103 in amplifier circuit 86 again serve to protect amplifier AR101 from excessive input voltages. Limiter 34, in this embodiment, is constructed from diode sets D104 and D105. These diodes serve to limit the voltage to generally no more than one diode drop. After passing through limiter 34, the signals on detect path 24 are input into notch filter 36. Notch filter 36 is designed to remove all frequencies in the desired signal bandwidth. Thus, the precise range of frequencies that are filtered by notch filter 36 will depend upon the strength of the magnetic field applied in the MMI system, along with the particular type of atoms being imaged. For example, in a 1.5 Tesla MRI system, the bandwidth of the desired signal would be 63.86 MHz plus or minus approximately 0.5 MHz, in an MRI system that imaged hydrogen. Interference detector and suppressor 20′ can be used with any magnetic field strength for imaging any desired atoms, and the bandwidth of the desired signals would be known to one skilled in the art. The output of notch filter 36 will therefore consist almost exclusively of thermal noise outside the desired signal bandwidth, along with any transient interference that may be present. The output of filter 36 is then amplified by amplifier AR103 before passing directly through resistors R161 and R162 along line 37. Line 37 is fed directly into the positive input terminal of comparator 38.

In the current embodiment of detector and suppressor 20′, resistors R161 and R162 have a value of 0 ohms. Resistors R161 and R162 are part of a contingent, low pass, filter 88 that is not operable in this embodiment. Contingent, low pass filter 88 may be rendered operative by assigning non-zero values to resistors R161 and R162. When operable, the purpose of low pass filter 88 is to remove any harmonics that may be added to the signal on receive path 26 due to voltage limiter 34. Because voltage limiter 34 essentially chops off signals of excessive amplitude, the large amplitude signals largely become square waves with many harmonics. Contingent, low pass filter 88 may be used to filter out these harmonics.

Comparator 38 compares the input voltages on lines 37 and 42 and produces a high output signal on line 46 whenever the voltage at input 37 exceeds the voltage at input 42. Comparator 38 generates no voltage, or a low voltage signal, when the voltage on input 42 exceeds the voltage on input 37. The output voltage of comparator 38 is then fed into a dual-shot monostable multivibrator 44. Multivibrator 44 opens switch 50 via lines C_1 and D_1 whenever the output of comparator 38 goes high more than once within a predetermined time period. As discussed above, a dual shot multi-vibrator has been selected because empirical data shows that transient interference, such as sparking, has a strong periodic component. Thus, the presence of transient interference will most likely trigger a high output in comparator 38 multiple times. In contrast, the thermal noise on input line 37 will not likely twice trigger a high output in comparator 38 over a short time period. Dual shot multi-vibrator 44 therefore provides additional discriminating capability for distinguishing between thermal noise and transient interference events.

The voltage threshold 42 in interference detector and suppressor 20′ is not automatically adjustable, as in interference detector and suppressor 20. Rather, the voltage threshold 42 is set at a constant, DC level in detector and suppressor 20′. Manual adjustments can be made, if desired, to effectively alter the threshold voltage at 42. Namely, manual adjustments can be made to variable resistor R116. These manual adjustments add a desired DC component to line 37 that is input into comparator 38. This added DC component has the same effect as if the voltage on line 42 were altered. It will be understood, of course, that the static voltage threshold on line 42 of interference detector and suppressor 20′ could be replaced with the automatic threshold adjustment circuit 40 of interference detector and suppressor 20.

The schematic in FIGS. 4A and 4B for interference detector and suppressor 20′ includes a number of test points, such as TP100-TP104. These test points have been implemented in this circuit solely for the purpose of testing and do not play any role in the functionality of the circuit. Interference detector and suppressor 20′ also includes a number of resistors having a value of zero ohms, such as resistors R108, R105, R132, R161, and R162. These zero ohm resistors have been included in the circuit solely to reduce the cost of the PC board design that implements this circuit in the case that contingencies arise where non-zero resistor values might be desirable.

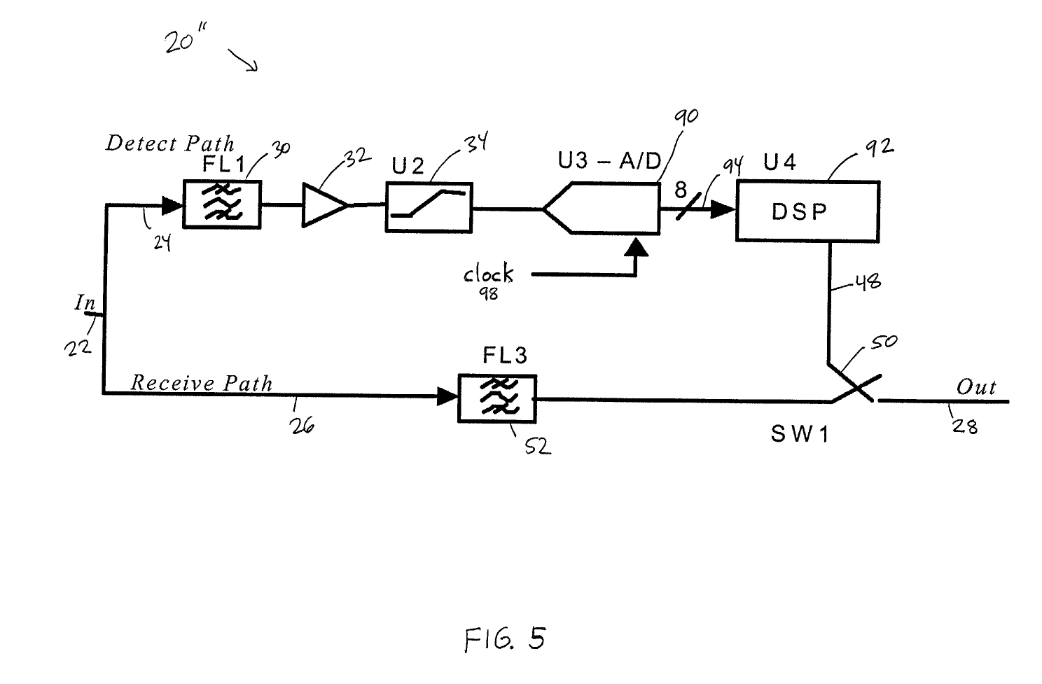

The block diagram of FIG. 5 depicts yet another embodiment of interference detector and suppressor 20″ that is implemented digitally. Interference detector and suppressor 20″ includes the following components that are the same as those found in interference detector and suppressor 20: input 22, detect path 24, receive path 26, bandpass filter 30, amplifier 32, limiter 34, bandpass filter 52, switch 50, and output 28. Interference detector and suppressor 20″ includes an analog to digital converter 90 and a digital signal processor 92 that are not present in interference detector and suppressor 20. Analog to digital converter 90 converts the analog output of limiter 34 into an 8-bit digital signal, which is then fed into an input 94 into digital signal processor 92. An alternative embodiment uses the inherent range limiting capability of the analog to digital converter in place of the limiter. Still another embodiment uses different number quantization levels (more or less bits in the analog to digital converter).

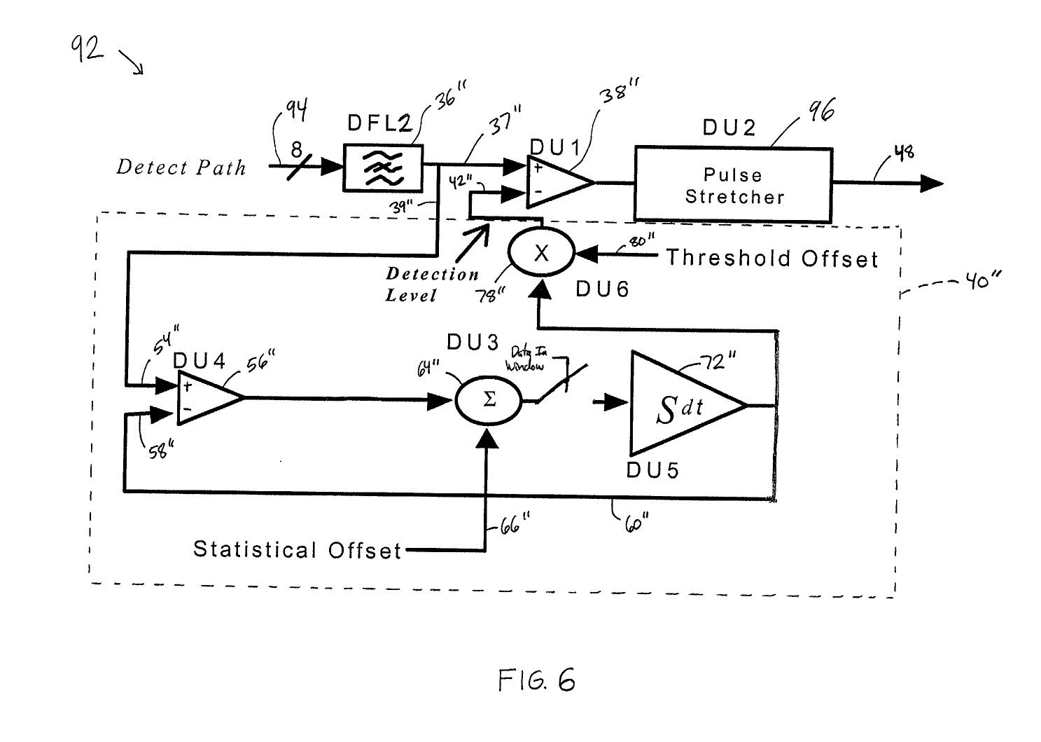

A detailed block diagram of digital signal processor 92 is depicted in FIG. 6. Digital signal processor 92 includes a digital notch filter 36″ which has the same functionality as notch filter 36, described previously, but which is instead implemented digitally. The output of digital notch filter 36″ is split along lines 37″ and 39″. Line 37″ feeds into the positive input terminal of a comparator 38″. Line 39″ feeds into an automatic threshold adjustment circuit 40″ , which is the same in all respects to automatic threshold adjustment circuit 40, with the exception that it is implemented digitally. Automatic threshold adjustment circuit 40″ produces a digital voltage on line 42″ that is fed into the negative input terminal of comparator 38″. The digital voltage on line 42″ is set at a desired number of standard deviations above the main value of the input on line 39″. Comparator 38″ thus functions in a manner identical to comparator 38, described previously. If the voltage on input 37″ exceeds the voltage on input 42″, comparator 38″ produces a high output that indicates the likely detection of transient interference. The output of comparator 38″ is fed into a pulse stretcher 96, which may be a dual-shot monostable multivibrator with the same settings as multivibrator 44, discussed previously. Pulse stretcher 96 will output a high signal on output 48 only if comparator 38″ produces a high output more than once within a predetermined time. A high output on line 48 will open switch 50, causing the receive path 26 to be blanked.

Interference detector and suppressor 20″ includes a clock for setting the rate at which the analog input to A-to-D converter 90 is sampled. While ideally this clock frequency would be greater than twice the highest expected input frequency, this may not be practical. Detector and suppressor 20″ can still be effectively operated when clock 90 has a frequency less than twice the highest expected input frequency, i.e. there is undersampling, in a variety of ways. In one method, bandfolding aliases the frequency range of interest (which may be about +/−10 MHz around the resonant frequency) into a single range at baseband. This technique is acceptable because the apparent loss of information is of no consequence, due to the fact that it is only the signals' energy content that is of interest, not any informational content. Such bandfolding has the further advantage of utilizing a clock speed that is well removed from the Larmor frequency, and thus less likely to cause interference. Other techniques are, of course, possible.

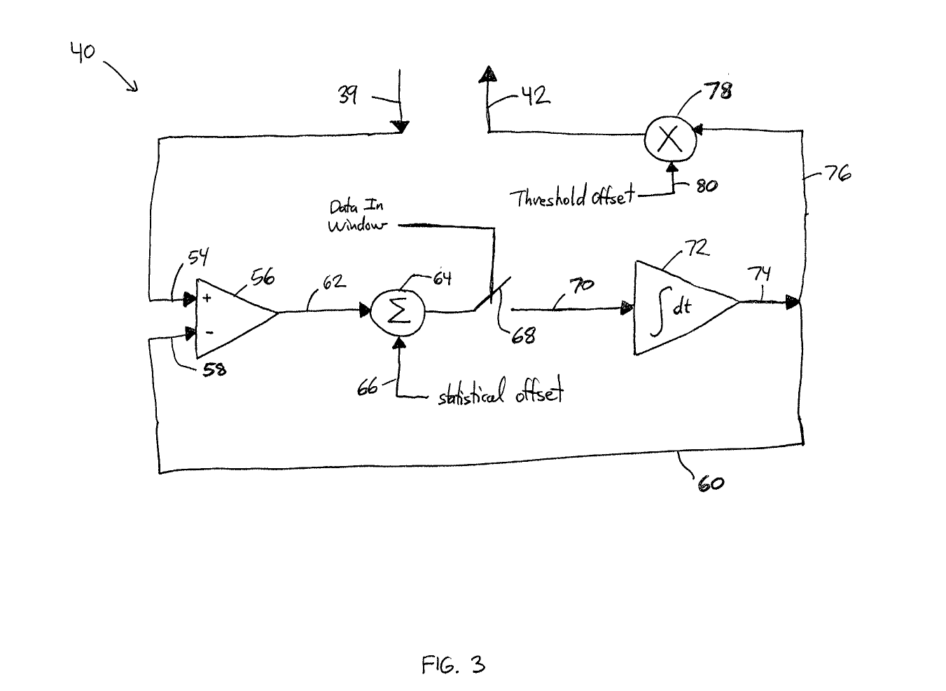

In additional to those embodiments depicted in FIGS. 1-6, it will be understood by one skilled in the art that various changes can be made to these embodiments without departing from the spirit of the invention. For example, the invention can be implemented using limiter 34 without multivibrator 44 and automatic threshold adjustment circuit 40. Alternatively, automatic threshold adjustment circuit 40 could be used without limiter 34 and multivibrator 44. Further, multivibrator 44 could be used without limiter 34 and automatic threshold adjustment circuit 40. Of course, it is also possible to use all of the different combinations of two of these three components without the third component. Additionally, the use of limiter 34, automatic threshold adjustment circuit 40 and multivibrator 44 have been depicted in the accompanying figures for use in blanking receive path 26. These components, however, could be used for other purposes besides blanking receive path 26. For example, if detect path 24 determines that transient interference is likely present, it may alternatively be desirable to take some other action other than blanking receive path 26. These other actions might include an attempt to insert a negative noise spike into receive path 26 that offsets the effects of the transient interference, or a re-scan signal may be generated indicating that the particular voxel being imaged that included the transient interference should be re-imaged at a later time. Other actions are, of course, possible. It also may be desirable to modify any of the embodiments of the interference detector and suppressor to include a counter that counts the number of times that transient interference is detected. Such a counter could include a display for indicating to personnel the presence or absence of transient interference.

While the present invention has been described in terms of the preferred embodiments depicted in the drawings and discussed in the above specification, along with several alternative embodiments, it will be understood by one skilled in the art that the present invention is not limited to these particular embodiments, but includes any and all such modifications that are within the spirit and the scope of the present invention as defined in the appended claims.

The embodiments of the present invention in which an exclusive property or privilege is claimed are defined as follows:

1. A method for detecting transient interference in a signal received from an MRI receiving antenna comprising:
passing said signal through a voltage limiter to produce a limited signal;
passing said limited signal through a filter designed to remove frequencies within said signal that are within a desired frequency bandwidth to produce a limited, filtered signal;
comparing said limited, filtered signal to a noise reference level; and
determining that said signal likely includes interference if said limited, filtered signal exceeds said noise reference level.

2. The method of claim 1 further including automatically adjusting said noise reference level.

3. The method of claim 2 wherein said automatic adjustment of said noise reference level includes taking statistical measurements of said limited, filtered signal and generating a threshold signal that has a probability of exceeding said limited, filtered signal a predetermined amount.

4. The method of claim 1 further including determining if said limited, filtered signal exceeds said noise reference level at least twice during a predetermined time period and concluding that said signal likely includes transient interference only if said limited, filtered signal exceeds said noise reference level at least twice during said predetermined time period.

5. The method of claim 4 further including determining an expected frequency component of said transient interference and setting said predetermined time period to be greater than twice said expected periodicity.

6. The method of claim 4 wherein said predetermined time period is on the order of 10 to 100 nanoseconds.

7. The method of claim 1 further including blanking said signal if said limited, filtered signal exceeds said noise reference level, and not blanking said signal if said limited, filtered signal does not exceed said noise reference level.

8. The method of claim 1 further including generating a re-scan signal if said limited, filtered signal exceeds said noise reference level.

9. A method for detecting transient interference in a signal received from an MRI receiving antenna comprising:
passing said MRI antenna signal through a filter designed to remove frequencies within said signal that are within a desired frequency bandwidth to produce a filtered signal;
comparing said filtered signal to a noise reference level; and
determining that said MRI antenna signal likely includes transient interference if said filtered signal exceeds said noise reference level at least twice within a predetermined time period.

10. The method of claim 9 further including passing said signal through a voltage limiter prior to passing said signal through said filter.

11. The method of claim 9 further including automatically adjusting said noise reference level.

12. The method of claim 11 further including automatically adjusting said noise reference level based on the statistical distribution of the filtered signal.

13. The method of claim 11 further including passing said signal through a voltage limiter prior to passing said signal through said filter.

14. The method of claim 9 wherein said predetermined time period is on the order of 10-100 nanoseconds.

15. The method of claim 9 further including blanking said signal if said filtered signal exceeds said noise reference level, and not blanking said signal if said filtered signal does not exceed said noise reference level.

16. The method of claim 9 further including generating a re-scan signal if said filtered signal exceeds said noise reference level

17. A transient interference detector system for detecting transient interference in an MRI signal received from a receiving antenna comprising:
a voltage limiter which receives said MRI signal and produces a limited signal;
a filter electrically coupled to said voltage limiter, said filter designed to remove frequencies within said limited signal that are within a desired frequency bandwidth to produce a filtered, limited signal; and
a noise detection circuit which compares the filtered, limited signal to a reference noise signal and produces a first output if said filtered, limited signal is greater than the noise reference signal, and produces a second output different from said first output if said filtered, limited signal is less than said noise reference signal.

18. The interference detector system of claim 17 further including an automatic adjustment circuit that automatically adjusts the level of said reference noise signal.

19. The interference detector system of claim 18 wherein said automatic adjustment circuit automatically adjusts said reference noise signal based upon the statistical distribution of the filtered, limited signal.

20. The interference detector system of claim 19 wherein said automatic adjustment circuit automatically produces a reference noise signal at a level that is desired number of standard deviations away from the mean value of the limited, filtered signal.

21. The interference detector system of claim 17 further including a timer that determines if said limited, filtered signal exceeds said noise reference signal at least twice during a predetermined time period, wherein said noise detection circuit produces said first output only if said limited, filtered signal exceeds said noise reference signal at least twice during said predetermined time period.

22. The interference detector system of claim 21 wherein said predetermined time period is on the order of 100 nanoseconds.

23. The interference detector system of claim 21 further including a switch that blanks said signal when said noise detection circuit produces said first output.

24. An interference detection system for detecting interference in a signal received from an MRI receiving antenna comprising:
a filter designed to remove frequencies within said signal that occur within a desired frequency bandwidth, said filter producing a filtered signal;
a comparator that compares said filtered signal to a noise reference signal; and
a detector that determines whether said filtered signal exceeds said noise reference signal at least twice within a predetermined time period.

25. The interference detection system of claim 24 further including a voltage limiter which limits the voltage of said signal prior to passing through said filter.

26. The interference detection system of claim 24 further including an automatic adjustment circuit that automatically adjusts the level of said reference noise signal.

27. The interference detection system of claim 26 wherein said automatic adjustment circuit automatically adjusts said reference noise signal based upon the statistical distribution of the filtered signal.

28. The interference detection system of claim 24 wherein said predetermined time period is on the order of 10-100 nanoseconds.

29. The interference detection system of claim 28 wherein said predetermined time period is set to be greater than twice the value of an expected frequency component of said transient interference.

30. The interference detection system of claim 25 further including an automatic adjustment circuit that automatically adjusts the level of said reference noise signal based on changes in the noise amplitude of said filtered signal.

31. A method for detecting transient interference in a signal received from an MRI receiving antenna comprising:
filtering out from said MRI signal frequencies that are within a desired signal bandwidth to produce a filtered signal;
generating a reference noise signal that has a voltage that is a desired number of standard deviations away from a mean value of said filtered signal;
comparing said filtered signal to said reference noise signal; and
determining that said filtered signal likely includes transient interference if said filtered signal exceeds said reference noise signal at least once.

32. The method of claim 31 wherein determining that said filtered signal likely includes transient interference occurs only if said filtered signal exceeds said reference noise signal at least twice within a predetermined time period.

33. The method of claim 32 further including limiting the voltage of said MRI signal prior to filtering out the frequencies within the desired signal bandwidth.

34. The method of claim 31 wherein generating the reference noise signal further includes determining a voltage that has a desired deviation from the mean value of said filtered signal, and multiplying said voltage by a multiplier to produce said reference noise signal.

35. A transient interference detector for detecting transient interference in a signal received from an MRI receiving antenna comprising:
a filter that filters out frequencies contained within said signal that are within a desired signal bandwidth, said filter producing a filtered signal;
an automatic noise adjustment circuit that generates a noise reference signal that has a desired probability of exceeding any thermal noise in said filtered signal; and
a comparator that compares said filtered signal to said noise reference signal and outputs a first signal if said filtered signal exceeds said noise reference signal and outputs a second signal if said noise reference signal exceeds said filtered signal.

36. The transient interference detector of claim 35 further including a voltage limiter which limits the voltage of said signal prior to passing through said filter.

37. The transient interference detector of claim 35 further including a timer that determines if said filtered signal exceeds said noise reference signal at least twice during a predetermined time period.
